(19) United States
(12) Patent Application Publication
(10) Pub. No.: US 2009/0148151 A1
(43) Pub. Date: Jun. 11, 2009

(54) OMNI-DIRECTIONAL CAMERA SYSTEM

(76) Inventors: Bin SHI, Hong Kong (CN); Xing Quan Li, Shenzhen (CN)

Correspondence Address: Muncy, Geissler, Olds & Lowe, PLLC, P.O. BOX 1364, FAIRFAX, VA, 22038-1364, US

(21) Appl. No.: 12/331,973

(22) Filed: Dec. 10, 2008

(30) Foreign Application Priority Data
Dec. 10, 2007 (CN) 200710164886.3

(51) Int. Cl. G03B 17/00

(52) U.S. Cl. 396/428

(57) ABSTRACT

Apparatus operable to change direction of an optic axis of a camera, the apparatus comprising: a first platform rotatable about a first axis of rotation; a second platform rigidly connected to the first platform; a camera mounting plate mounted to the second platform so that the mounting plate is rotatable about a second axis; and at least one piezoelectric motor coupled to the first platform and the mounting plate operable to selectively rotate the first platform about the first axis and the mounting plate about the second axis.

### CROSS REFERENCE TO RELATED APPLICATIONS

This non-provisional patent application claims priority under 35 U.S.C. § 119(a) from Patent Application No. 200710164886.3 filed in The People's Republic of China on 10 Dec. 2007.

### FIELD OF THE INVENTION

Embodiments of the invention relate to an “omni-directional” camera system operable to orient an optical axis of a camera in a substantially 4π steradian solid angle of directions.

### BACKGROUND OF THE INVENTION

Omni-directional camera systems that are operable to orient a camera to image scenes in a relatively wide range of different directions are relatively common and are used in many different applications. They may be used for example for surveillance and/or alarm systems and for robotic vision.

Generally, these systems comprise an electromagnetic motor coupled to a camera by a relatively complicated transmission system. The motor and transmission system are controllable to point an optic axis of the camera in a relatively wide range of directions so that the camera can image scenes in an extended field of view that is substantially larger than the camera field of view.

U.S. Pat. No. 7,274,805 describes an omni-direction camera system that comprises “a rotary electric machine for horizontally rotating (panning)” a camera. The electric machine is coupled to the camera using a relatively complicated set of shafts and a reduction gear.

U.S. Pat. No. 7,268,819 describes a “scanning camera comprising: an imaging device for capturing an image having an image pickup element, a support shaft attached to the imaging device for changing a photographing direction, a frame for supporting the imaging device through the support shaft, a driver attached to the frame for rotating the imaging device, and a flexible connector electrically connected to the image pickup element and having two planar portions, said two planar portions extending to the frame from at least two positions of the imaging device at opposite sides relative to an axis of the support shaft diagonally away from each other such that the two planar portions of the flexible connector are arranged parallel to the axis of the support shaft.”

Some surveillance and scanning systems use an optical system for providing an extended field of view for a camera. U.S. Pat. No. 7,190,259 describes a surveillance system for use on a mobile body that has an optical system for providing an extended field of view. The system has “an omni directional vision sensor comprising an optical system for reflecting light incident from a maximum surrounding 360-degree visual field area toward a predetermined direction and an imaging section for imaging light reflected from the optical system to obtain image data”.

### SUMMARY

An aspect of some embodiments of the invention relate to providing a relatively simple omni-directional camera system operable to orient a camera to image a scene in a relatively large range of different directions.

According to an aspect of some embodiments of the invention, the omni-directional camera system is configured to point an optical axis of a camera comprised in the system in substantially any direction in a solid angle substantially equal to 4π steradians.

An aspect of some embodiments of the invention relates to providing a relatively small omni-directional camera system.

An aspect of some embodiments of the invention relates to providing a relatively simple transmission system for coupling a motor to a camera optionally comprised in an omni-directional camera system so that the motor is operable to change direction of the optic axis of the camera. Optionally, the transmission system couples at least one piezoelectric motor to the camera.

According to an aspect of an embodiment of the invention, the transmission system comprises first and second platforms rotatable about a first axis of rotation and a camera mounting plate mounted to the second platform so that the mounting plate is rotatable about a second axis of rotation.

In an embodiment of the invention, the first and second axes of rotation are substantially perpendicular to each other. A camera is mounted to the mounting plate and has an optical axis optionally substantially perpendicular to the second axis of rotation. The camera optical axis can be pointed in substantially any direction in a 4π steradian range of directions by rotating the first and second platforms and the mounting plate about their respective axes of rotation.

In an embodiment of the invention, the first platform is friction coupled to a piezoelectric motor controllable to rotate the first and second platforms about the first axis of rotation. In an embodiment of the invention, the camera mounting plate is friction coupled to a piezoelectric motor controllable to rotate the mounting plate about the second axis of rotation.

### BRIEF DESCRIPTION OF THE FIGURES

Examples illustrative of embodiments of the invention are described below with reference to figures attached hereto. In the figures, identical structures, elements or parts that appear in more than one figure are generally labelled with a same numeral in all the figures in which they appear. Dimensions of components and features shown in the figures are generally chosen for convenience and clarity of presentation and are not necessarily shown to scale. The figures are listed below.

FIGS. 1A-1D schematically show an omni-directional camera system comprising a camera mounted to a transmission system having first and second platforms rotated by piezoelectric motors, in accordance with an embodiment of the invention;

FIGS. 2A-2B schematically show different views of a variation of the camera system shown in FIGS. 1A-1D;

FIGS. 3A-3C schematically show different views of another variation of the camera system shown in FIGS. 1A-1D;

FIG. 4A schematically shows another camera system comprising first and second platforms rotated by piezoelectric motors in accordance with an embodiment of the invention;

FIG. 4B schematically shows a version of the camera system shown in FIG. 4A in accordance with an embodiment of the invention; and

FIG. 5 schematically shows another variation of the camera system shown in FIGS. 3A-3C.

### DETAILED DESCRIPTION OF PREFERRED EMBODIMENTS

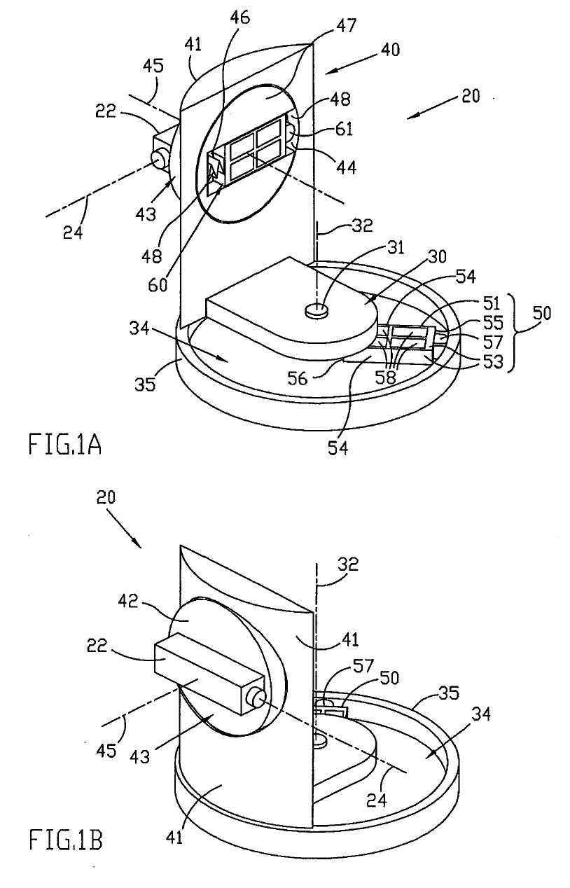

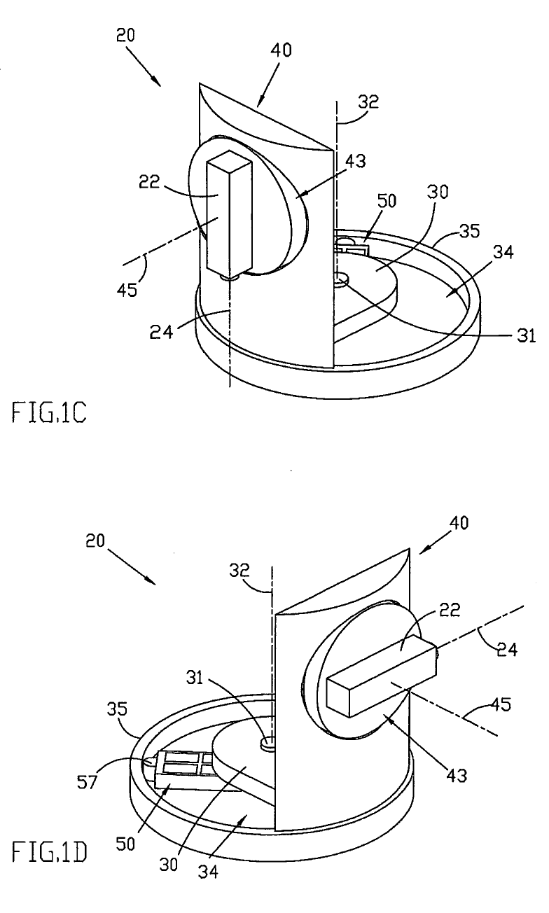

FIGS. 1A-D schematically show an omni-directional camera system 20 comprising a camera 22 having an optic axis indicated by a dashed line 24 and first and second platforms 30 and 40, in accordance with an embodiment of the invention. In an embodiment of the invention first and second platforms 30 and 40 are rigidly connected.

First rotatable platform 30 is optionally fixed to a shaft 31 having a first axis 32 rotatably mounted to a base plate 34 having a circular contact rim 35. Contact rim 35 forms an annulus having a centre collinear with the first axis 32. At least one piezoelectric motor 50 is mounted to first platform 30, using any suitable mounting frame (not shown) known in the art so that it does not rotate relative to the platform and is operable to apply force to rim 35, which generates a torque that rotates the first platform and therefore the second platform about axis 32.

Optionally piezoelectric motor 50 is a type of motor described in U.S. Pat. No. 5,453,653, the disclosure of which is incorporated herein by reference. The motor comprises a thin rectangular ceramic piezoelectric vibrator 51 having front and back planar face surfaces 53, of which only an edge of back surface 53 is seen in the perspective of the figure, relatively long edge surfaces 54 and relatively short top and bottom edge surfaces 55 and 56 respectively. A friction nub 57 is located on short edge 55 of the vibrator 51.

Optionally, four quadrant electrodes 58 are located in a symmetric checkerboard pattern on front face surface 53. A single large electrode (not shown) is located on back surface 53. A controller, not shown, electrifies quadrant electrodes 58 to generate vibrations in the vibrator 51 of piezoelectric motor 50 and thereby in friction nub 57 to apply force to rim 35 and generate torque that rotates first and second platforms 30 and 40 selectively clockwise or counter clockwise about axis 32.

Optionally, second platform 40 rests on rim 35 so that it slides relatively freely on the rim. Optionally, second platform 40 has a cylindrical outer surface 41 having a circular directrix whose center of rotation lies on axis 32. Camera 20 is optionally mounted to an outside surface 42 (FIG. 1B) of an optionally circular disk-like camera mounting plate 43. The camera mounting plate seats in a circular recess 44 in second platform 40 so that the mounting plate is freely rotatable about an axis 45. A piezoelectric motor 60 having a friction nub 61, optionally similar to piezoelectric motor 50 is mounted in a slot 46 formed on an inside surface 47 of mounting plate 43. A resilient element 48 urges the motor 60 so that its friction nub 61 presses resiliently against a surface 49 of recess 44.

The controller controls electrification of the piezoelectric motor 60 to generate vibrations in the motor's friction nub 61 and thereby apply force to surface 49 to generate torque to selectively rotate camera-mounting plate 43 clockwise or counter clockwise about second axis 45. Optionally second axis 45 is perpendicular to first axis 32. By controlling piezoelectric motor 50 to rotate first and second platforms through an appropriate angle about axis 32 and piezoelectric motor 60 to rotate camera mounting platform 43 about axis 45 through an appropriate angle, the controller positions optic axis 24 of camera 20 along substantially any direction in a 4π steradian solid angle of directions.

By way of example, FIGS. 1A-1D schematically show first and second platforms 30 and 40 rotated about axis 32 and mounting plate 43 about axis 45 to orient optic axis 24 of camera 22 along different directions. It is noted that curvature of outside surface 41 tends to reduce blockage of the field of view of camera 20 when the camera optic axis has a direction having a relatively large component perpendicular to axis 32.

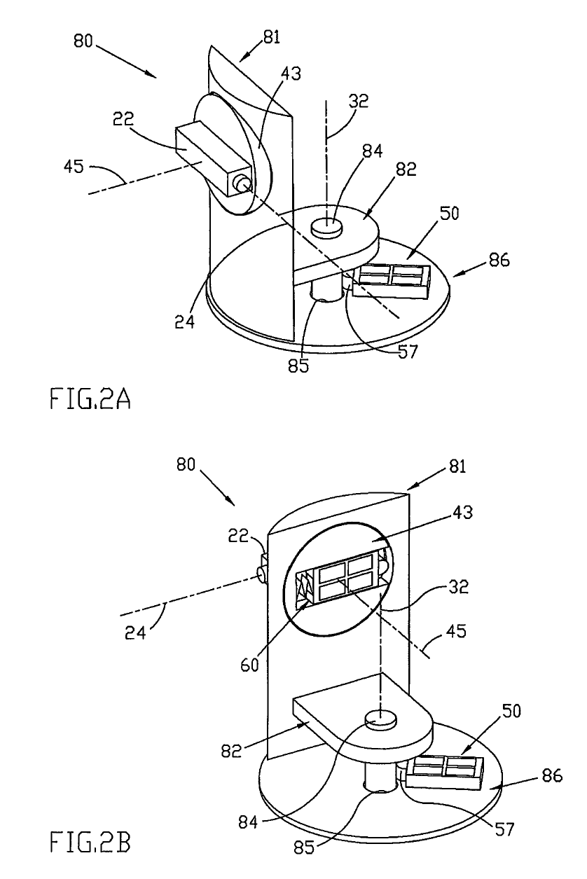

FIGS. 2A and 2B schematically show an omni-directional camera system 80 in accordance with an embodiment of the invention, that is a variation of omni-direction camera system 20. Omni-directional camera system 80 comprises a second platform 81 mounted to a first platform 82. Second platform 81 is optionally identical to second platform 40 in omni-directional system 20 shown in FIGS. 1A-1D and comprises a camera mounting plate 43 to which a camera 22 and piezoelectric motor 60 are mounted. Mounting plate 43 seats in a recess so that it is relatively freely rotatable about an axis 45. First platform 82 is fixed to a shaft 84 that is rotatably mounted in a socket 85 in a base plate 86.

However, unlike base plate 34, in omni-directional camera 20, base plate 86 does not have a rim 35 and first platform 82 in omni-directional camera 80 does not have a piezoelectric motor fixed to it. Instead omni-directional camera 80 has at least one piezoelectric motor 50 mounted to base plate 86 so that its friction nub 57 resiliently presses on the surface of shaft 84. A controller, not shown, controls piezoelectric motor 50 to excite vibrations in its friction nub 57 to selectively rotate shaft 84 and thereby first and second platforms 82 and 81 clockwise or counter clockwise about an axis 32 of the shaft. The controller controls piezoelectric motor 60 to rotate camera mounting plate 43 about axis 45.

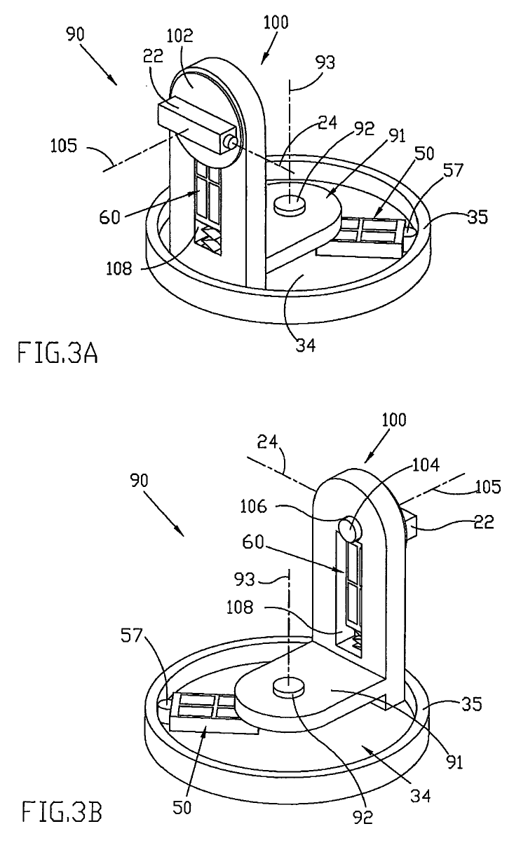

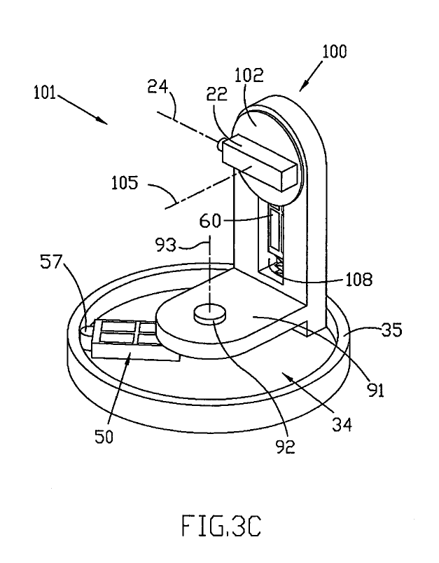

FIGS. 3A and 3B schematically show an omni-directional camera system 90 in accordance with an embodiment of the invention.

Similarly to omni-directional camera system 20, omni-directional camera system 90 comprises a first platform 91 having a shaft 92 rotatably mounted to a base plate 34 having a rim 35. A piezoelectric motor 50 mounted to first platform 91 has a friction nub 57 that is resiliently pressed to rim 35. A controller, not shown, controls vibration in piezoelectric motor 50 to rotate first platform 91 selectively clockwise or counter clockwise about an axis 93 of shaft 92.

A second platform 100 is mounted to first platform 91 and rests on base plate 34 so that it is readily freely moved along the base plate. A camera 20 having an optic axis 24 is mounted to a camera mounting plate 102 comprising a shaft 104 having an axis 105 that is rotatably mounted in a socket 106 in second platform 100. A piezoelectric motor 60 optionally mounted in a slot 108 in the second platform that communicates with socket 106 is resiliently urged towards shaft 104 so that a friction nub 61 of the motor presses on the surface of the shaft. The controller controls vibrations of piezoelectric motor 60 to selectively rotate shaft 104 and camera mounting platform 102 about the shaft axis. The controller controls piezoelectric motors 50 and 60 to rotate camera mounting plate 102 and its camera 20 to orient camera axis 24 in a desired direction.

FIG. 3C schematically shows an omni-directional camera system 101 that is a variation of camera system 90 shown in FIGS. 3A and 3B, in accordance with an embodiment of the invention.

Camera system 101 is similar to camera system 90 except that camera mounting plate 102 and camera 22 are positioned on a side of platform 100 facing axis 93 rather than on a side of the platform facing away from the axis.

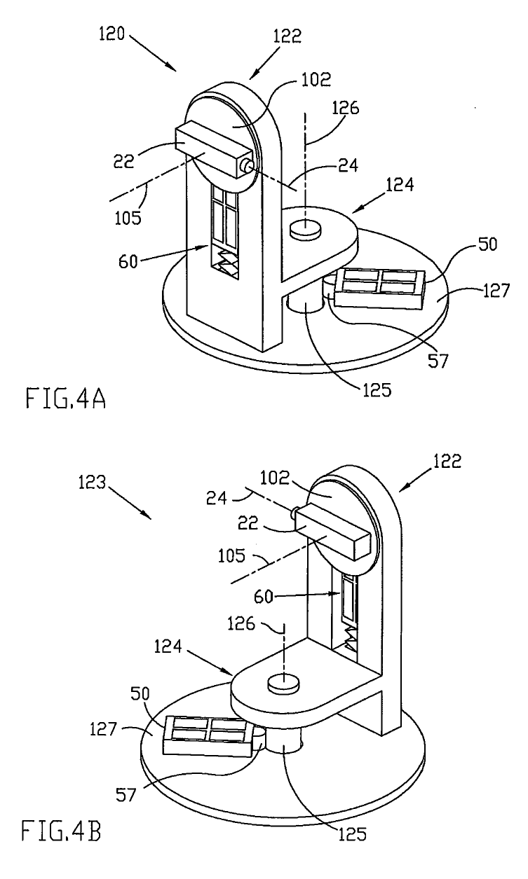

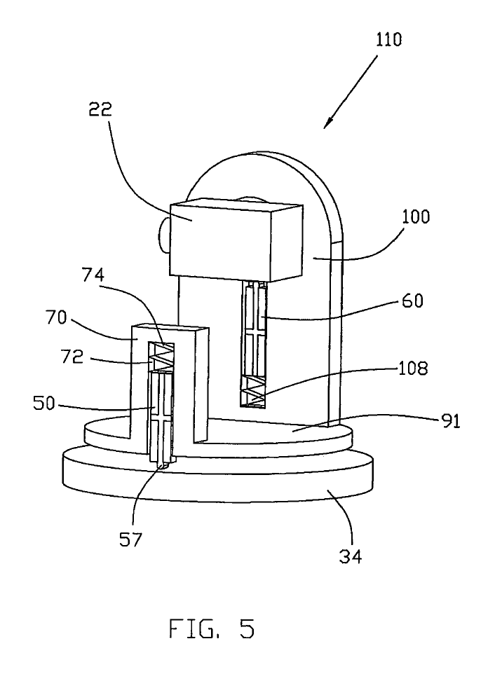

FIG. 4A schematically shows yet another omni-directional camera system 120 that is a variation of omni-directional camera system 90. Omni-directional camera system 120 comprises a second platform 122 optionally identical to second platform 100 comprised in omni-directional camera system 90. The second platform comprises a camera mounting plate 162, which is rotated about an axis 105 by a piezoelectric motor 60. A camera having an optic axis 24 is mounted to camera mounting plate 102. Second platform 122 is mounted to a first platform 124 having a shaft 125 having an axis 126 rotatably mounted to a base plate 127.

First platform 124 in omni-directional camera 120 is similar to first platform 91 comprised in omni-directional camera system 90. However, unlike first platform 91, a piezoelectric motor is not mounted to first platform 124 and base plate 127 optionally does not have a rim 35 as does base plate 34 in omni-directional camera system 90. Instead, a piezoelectric motor 50 is mounted to base plate 127 so that its friction nub 57 resiliently presses against shaft 125. A controller, not shown, controls piezoelectric motors 60 and 50 to rotate camera mounting plate 102 about axes 105 and 126 respectively to orient optic axis 24 of camera 22 in a desired direction.

FIG. 4B schematically shows an omni-directional camera system 123 that is a variation of camera system 120 shown in FIGS. 4A, in accordance with an embodiment of the invention.

Camera system 123 is similar to camera system 120 except that camera mounting plate 102 and camera 22 are positioned on a side of platform 122 facing axis 126 rather than on a side of the platform facing away from the axis.

FIG. 5 schematically shows an omni-directional camera system 110, in accordance with an embodiment of the invention, which is similar to the omni-directional camera system of FIG. 3C. Similar to omni-directional camera system 101, omni-directional camera system 110 comprises a first platform 91 rotatably mounted to a base 34.

A second platform 100 is mounted to or extends from first platform 91. A camera 20 is mounted to a camera mounting plate and shaft (not shown) rotatably mounted to the second platform and rotatable by a second piezoelectric motor 60, optionally mounted in a slot 108 in the second platform as per the arrangement of the embodiment of FIGS. 3A-3C.

The first platform 91 has a motor mount 70 extending from the platform optionally in a direction substantially parallel to the axis of rotation of the platform 91 and in a direction away from the base 34. Motor mount 70 has a slot 72 for receiving the first piezoelectric motor 50 and resilient means in the form of a spring 74 for urging the nub 57 of the first piezoelectric motor into frictional contact with a surface of the base 34. The controller, not shown, controls vibration in the first piezoelectric motor 50 to rotate the first platform 91 selectively clockwise or counterclockwise with respect to the base 34.

As a variation, the first piezoelectric motor 50 could be mounted to the first platform 91 within a recess formed in the second platform 100 so as to lie next to and parallel to the second piezoelectric motor 60, although facing in the opposite direction. Moreover, motor mount 70 could be located next to, formed as a part of or combined with, the second platform 100.

In the description and claims of the present application, each of the verbs, “comprise” “include” and “have”, and conjugates thereof, are used to indicate that the object or objects of the verb are not necessarily an exhaustive listing of members, components, elements or parts of the subject or subjects of the verb.

The invention has been described with reference to embodiments thereof that are provided by way of example and are not intended to limit the scope of the invention. The described embodiments comprise different features, not all of which are required in all embodiments of the invention. Some embodiments of the invention utilize only some of the features or possible combinations of the features. Variations of embodiments of the described invention and embodiments of the invention comprising different combinations of features than those noted in the described embodiments will occur to persons of the art.

For example, for any of the motor and platform configurations, the camera mounting plate can be mounted so as to have the optic axis of the camera, the first axis (the rotational axis of the first platform) and the second axis (the rotational axis of the camera mounting plate), all intersect at a single point. Also, to give a smoother image movement, there may be an advantage in having the centre of the image plane of an image sensor of the camera aligned with the intersection of the first axis and the second axis.

1. Apparatus operable to change direction of an optic axis of a camera, the apparatus comprising:
a first platform rotatable about a first axis of rotation;
a second platform rigidly connected to the first platform;
a camera mounting plate mounted to the second platform so that the mounting plate is rotatable about a second axis; and
at least one motor coupled to the first platform and the mounting plate operable to selectively rotate the first platform about the first axis and the mounting plate about the second axis.

2. The apparatus of claim 1, wherein the first axis and second axis are perpendicular to each other.

3. The apparatus of claim 1, wherein the at least one motor comprises at least one first piezoelectric motor mounted to the first platform.

4. The apparatus of claim 3, further comprising an annulus having a center collinear with the first axis, wherein the at least one first motor is coupled to the annulus and controllable to apply force to the annulus, which force generates a torque that rotates the first platform about the first axis.

5. The apparatus of claim 1, further comprising a shaft connected to the first platform having an axis collinear with the first axis of rotation.

6. The apparatus of claim 5, further comprising at least one first piezoelectric motor friction coupled to the shaft and operable to apply force to the shaft which generates a torque that rotates the shaft and thereby the first platform about the first axis.

7. The apparatus of claim 1, further comprising at least one second piezoelectric motor mounted to the camera mounting plate.

8. The apparatus of claim 7, wherein the second platform comprises an annular surface having a center collinear with the second axis and the at least one second motor is coupled to the annular surface and controllable to apply force to the annular surface that generates a torque, which rotates the mounting plate about the second axis.

9. The apparatus of claim 1, further comprising a shaft mounted to the camera mounting plate having an axis collinear with the second axis.

10. The apparatus of claim 9, comprising at least one second piezoelectric motor mounted to the second platform and coupled to the shaft so that it is operable to apply force to the shaft, which generates a torque that rotates the shaft and thereby the camera mounting plate about the second axis.

11. The apparatus of claim 3, wherein the first piezoelectric motor is mounted to the first platform in a direction generally parallel to the first axis.

12. The apparatus of claim 11, wherein the first platform has a motor mount having a slot for receiving the first piezoelectric motor and spring means for resiliently urging a nub of the first piezoelectric motor into frictional engagement with a surface of the base.
